(19) United States
(12) Patent Application Publication
(10) Pub. No.: US 2024/0413895 A1
(43) Pub. Date: Dec. 12, 2024

(54) PREDICTION OF FADE OUTAGES

(71) Applicant: United Kingdom Research and Innovation, Swindon Wiltshire (GB)

(72) Inventors: Charilaos Kourogiorgas, Oxfordshire (GB); Spyridon Ventouras, Oxfordshire (GB)

(73) Assignee: United Kingdom Research and Innovation, Swindon Witshire (GB)

(21) Appl. No.: 18/700,822

(22) PCT Filed: Oct. 7, 2022
(86) PCT No.: PCT/GB2022/052541

§ 371 Date: Apr. 12, 2024

(30) Foreign Application Priority Data
Oct. 14, 2021 (GB) 2114694.9

(51) Int. Cl. H04B 7/185; H04B 17/391

(52) U.S. Cl. CPC H04B 7/18534; H04B 17/3911

(57) ABSTRACT

The disclosure relates to methods and apparatus for providing a prediction of fade outage of a feeder link between a satellite and a ground station within a prediction time interval. Rainfall forecast data for the gateway is received for a plurality of forecast time intervals which comprise a plurality of time intervals after the prediction time interval. The rainfall forecast data is then input to a trained fade outage model, which outputs the prediction of fade outage in response to the input.

The present disclosure relates to methods and apparatus for predicting fade outages, for example fade outages of feeder links (radio beam links) between an orbiting satellite and each of a plurality of ground station gateways, and for controlling of a group of feeder links using such predictions. Such methods and apparatus may be used in a smart gateway diversity scheme for switching the flow of data traffic between the gateways.

### INTRODUCTION

Feeder links between satellites and gateway stations on the ground, at higher frequency bands such as the Ka and Q/V bands, are more vulnerable than links at lower radio frequencies to atmospheric disturbances within the radio beam such as water vapour, turbulence, cloud, and especially rain. Such disturbances can lead to regular increases in fading due to atmospheric attenuation of the beam between an orbiting satellite and a ground station. When the fading exceeds an available fade margin, use of that particular data link becomes impractical due to low levels of signal to noise ratio and a fade outage may then be deemed to occur.

Smart gateway diversity is a known technique which exploits the geographical spatial diversity provided by having multiple ground gateways communicating with the same satellite in order to increase availability of the group of feeder links for that satellite. Two main forms of smart gateway diversity which have been proposed are:
(i) the use of N normally active gateways (“N active” scheme), with each gateway being oversized in terms of data traffic capacity so that when one gateway experiences a fade outage, the remaining gateways usually have sufficient spare capacity to take over the traffic of that gateway; and
(ii) the use of N active and P standby gateways (“N active+P standby” scheme), in which each of the N active gateways may be fully loaded in terms of traffic, and if one such active gateway is lost due to a fade outage then one of the P standby gateways is switched in to take over the traffic of the lost gateway. The lost gateway may subsequently join the pool of P standby gateways, so as to take over traffic either when the fading has reduced sufficiently, or when switching is again required due to a fade outage of the one of the currently active gateways.

However, there are operational and implementation penalties and compromises involved with either scheme, or indeed with other smart gateway diversity schemes. Each time a switch of traffic between gateways takes place, this may be associated with a short switching delay during which at least the switched traffic, and perhaps all traffic in the group of feeder links is halted. Additionally, although a group of feeder links can be designed to reduce individual fade outages for example by increasing antenna sizes, and to reduce the frequency of insufficient gateway capacity being available for the current traffic load, for example by providing more standby gateways, such measures will usually only be available at increased cost.

A primary metric for assessing a smart gateway diversity scheme may be the achievable availability of the group of feeder links, which depends on the number of fade outages (typically due to rainfall), and the number of resulting required switches between gateways in combination with the associated switching delay. For the “N+P” scheme, at any instant the group of feeder links is fully available if N or more gateways out of the N+P gateways are not in outage. Over a period of interest, such as a year, the availability of the group of feeder links may then be defined as the percentage of that period that the group of feeder links is fully available.

It would be desirable to operate a group of feeder links using a smart gateway diversity scheme in ways which further increase the availability of those feeder links to the satellite. It would also be desirable to be able to design a group of feeder links and associated gateways and control systems so as to optimize the design for a required level of expected feeder link availability to a satellite.

More generally, it would be desirable to address problems and limitations of the related prior art.

### SUMMARY OF THE INVENTION

Aspects of the invention relate to the use of spatial gateway diversity to exploit the geographical spatial diversity provided by using multiple ground station gateways in communication with a satellite using different feeder links or beams, in order to increase the ground network availability. The described techniques use both local rainfall data and attenuation data for a ground station gateway in order to train an artificial intelligence (AI) or statistical model, which can then be used to make predictions of fade outage within an operational system, or to evaluate the expected performance of particular network designs under various expected real World conditions.

Typically, embodiments of the invention are arranged to operate with feeder links between ground stations and a satellite in the Ka and Q/V bands. IEEE standards, for example 521-2002 typically designate the Ka band as 27 to 40 GHz, and the Q/V band as 40 to 75 GHz.

According to a first aspect, the invention provides a method of forecasting or predicting fade outage, for example predicting whether a fade outage will occur, by using rainfall forecast data for a ground station as input to a trained fade outage model (which may be referred to as an artificial intelligence or statistical prediction model), and preferably using such rainfall forecast data for at least after, and optionally for both before and after the time for which the prediction is being made. In either case, rainfall forecast data for the time for which the prediction is being made may also be used.

More particularly, the invention provides a method of providing a prediction of fade outage of a feeder link between a satellite and a ground station gateway within a prediction time interval comprising: receiving rainfall forecast data for the gateway for a plurality of forecast time intervals which comprise time intervals after, or both time intervals before and time intervals after, the prediction time interval; providing the rainfall forecast data as input to a trained fade outage model; and outputting by the trained fade outage model, in response to the input, the prediction of fade outage for the prediction time interval, for example a prediction of whether or not the feeder link will experience fade outage within the prediction time interval.

A fade outage typically occurs when the feeder link becomes impractical to use due to excessive atmospheric attenuation, usually due to rainfall within the beam of the connection. Typically, a fade outage may be deemed to occur if attenuation of the feeder link exceeds a given or predefined threshold, which is typically related to, or may be defined by or as, a fade margin or site switching threshold (SST) for the gateway or system, although other criteria may be used. A fade outage may then also be predicted if such an occurrence is expected according to a fade outage model or other prediction mechanism.

The plurality of forecast time intervals may for example comprise at least one, or at least three, time intervals after, or each of at least three time intervals before and three time intervals after the prediction time interval. Optionally, each forecast time interval may be one or more of: at least one minute in length, at least five minutes in length, not more than thirty minutes in length, and not more than sixty minutes in length. The prediction time interval may be one or more of at least one minute in length, at least five minutes in length, not more than thirty minutes in length, and not more than sixty minutes in length. The lengths of the time intervals used may depend for example on the time intervals in available rainfall forecast data.

One or more other measures, data, or parameters may be used as additional input to the trained outage model in order to predict a fade outage, such as: atmospheric temperature, such as temperature forecast data for one or more time intervals that at least overlap with at least one of the forecast time intervals or the prediction time interval; wind speed, such as wind speed and/or direction forecasts; azimuthal angle between a ground station and satellite; and elevation, latitude or similar, for example an elevation measure representative of an elevation angle between the ground station and the satellite.

The inventors have noted that use of data describing recent fade outages, for example in the last hour or two, as input to the fade outage model, can also improve the quality of the prediction. Fade outage data may therefore also be provided as part of the input to the trained outage model. For example, the fade outage data may represent actual fade outages of the feeder link within one or more time periods before the prediction interval, wherein the one or more time periods optionally lie within one hour before, or within two hours before the prediction time interval.

The inventors have also found that the training and use of the fade outage model is improved if the prediction of fade outage is made as a choice between a very limited number of options, for example as a binary prediction of whether or not a fade outage will occur within the prediction time interval. However, a multiclass prediction for example with from three to five classes of output may also be used. Such classes could indicate, for example, a limited number of discretised likelihoods of any fade outage occurring within the prediction time interval, or a number of discretised values of expected duration of fade outage within the prediction time interval.

The predictions of fade outage may be used to control a group of feeder links between a plurality of ground station gateways and one or more satellites. Such a method may comprise: making the described predictions of fade outage of feeder links between a satellite and each of a plurality of ground station gateways; and controlling the switching of data traffic between the gateways at least partly on the basis of the predictions of fade outage. For example, the switching of data traffic may include ceasing transmission on one telecommunication connection which is expected before an expected fade outage for that connection, and switching transmission to another feeder link which is not expected to experience fade outage at the same time. In other words, controlling switching of data traffic may comprise making an active ground station gateway inactive and/or making an inactive ground station active, at least partly on the basis of one or more of the predictions of fade outage.

Each feeder link may be in one of a plurality of radio frequency bands, such as the Ka and V bands, and the described methods may then further comprise providing a plurality of fade outage models such that each fade outage model is specific to one of said radio frequency bands, each prediction of fade outage being made using a fade outage model specific to the frequency band of the associated feeder link.

If each ground station gateway has an associated site switching threshold, SST, and there are a plurality of different such SSTs, so that different groups of one or more ground station gateways use different SSTs, then the described methods may further comprise providing a plurality of fade outage models such that each fade outage model is specific to one of said SSTs, each prediction of fade outage being made using a fade outage model specific to the SST of the associated feeder link.

The invention also provides methods of generating or training one or more fade outage models for use as discussed above, for example a method of training a fade outage model for use in predicting fade outage of feeder links, comprising: providing training data comprising one or more time series of rainfall and training data indicating fade outage arising from the rainfall, and using the training data to train the fade outage model to predict if one or more of the fade outage criteria will be met for a future prediction interval, using as 10 input to the fade outage model rainfall forecast data for a plurality of forecast time intervals which comprise time intervals after, or both time intervals before and time intervals after, the prediction time interval.

More particularly, such a method may involve providing training data comprising one or more time series of rainfall and one or more corresponding time series of attenuation of the feeder link, each time series of rainfall being for the same ground station gateway as a corresponding time series of attenuation; defining one or more fade outage criteria which are at least partly dependent on the attenuation; and using the training data to train the fade outage model to predict if one or more of the fade outage criteria will be met for a future prediction interval, using as input to the fade outage model rainfall forecast data for a plurality of forecast time intervals which comprise time intervals after, or both time intervals before and time intervals after the prediction time interval.

The one or more fade outage criteria may for example comprise the attenuation meeting, or exceeding a given or predefined threshold, which is typically related to or May be defined by or as a fade margin or site switching threshold (SST) for the gateway or system, or may be predicted if such an occurrence is expected.

Typically, the plurality of forecast time intervals may comprise at least three time intervals after, or both at least three time intervals before and at least three time intervals after the prediction time interval.

The invention also provides apparatus corresponding to the above methods, including apparatus arrange to make fade outage predictions, and apparatus for controlling a feeder network comprising a satellite and a plurality of ground station gateways. Such apparatus may then comprise: one or more fade outage models arranged to make predictions of fade outage of feeder links between the satellite and the ground station gateways, each fade outage model being arranged to receive as input, rainfall forecast data for the gateway for a plurality of forecast time intervals which include time intervals after, or both time intervals before and time intervals after, a prediction time interval, and to output, in response to the input, a prediction of fade outage for the prediction time interval.

Such apparatus may further comprise a switching planner, the switching planner being arranged to receive the predictions of fade outage from the one or more fade outage models, and to generate, modify, or output a switching plan which schedules switches of data traffic between the ground station gateways. For example, such as switching plan may schedule switching of active ground station gateways carrying data traffic to an inactive status, and inactive ground station gateways not carrying data traffic to active status.

Such apparatus may then further comprise a gateway switching controller arranged to switch data traffic between gateways according to the switching plan.

The invention also provides one or more computer readable media carrying computer program code arranged such that, when executed on one or more suitable computer systems, the above methods and apparatus are put into effect. Such computer program code may, for example, be arranged to provide a prediction of fade outage, to provide aspects of smart gateway diversity control, including for example controlling ground station gateways, or to train a fade outage model as variously discussed herein.

The invention also provides one or more fade outage models as described herein.

### BRIEF SUMMARY OF THE DRAWINGS

Embodiments of the invention will now be described, by way of example only, with reference to the accompanying drawings of which:

FIG. 1 illustrates a plurality of ground station gateways communicating with a satellite under a smart gateway diversity scheme;

FIG. 2 show in more detail how the smart gateway diversity controller of FIG. 1 may be implemented;

FIG. 3 illustrates rainfall forecast data over a plurality of time intervals some of which are before, some of which are after, and one of which is during, a prediction interval, for use in training a fade outage model, or for making a prediction of fade outage using such a model;

FIG. 4 shows average precisions of some fade outage model trained and tested using a number of forecast data time intervals only prior to a prediction time interval, and other fade outage models trained and tested using corresponding numbers of forecast time intervals only after a prediction time interval, in each case in addition to forecast data for the prediction time interval itself;

FIG. 5 illustrates some data elements which may be provided as input to a fade outage model in order for a fade outage prediction X to be made;

FIG. 6 shows how a plurality of differently trained fade outage models may be used for different gateways, for example for multiple gateways with feeder links which operate in different wavelength bands or using different site switching thresholds;

FIG. 7 illustrates how a fade outage model of FIG. 2, 4 or 5 may be trained; and

FIG. 8 illustrates predictions of fade outage made by a trained fade outage model (lower bars) compared with subsequently experienced fade outages (bars within plot of attenuation).

### DETAILED DESCRIPTION OF EMBODIMENTS

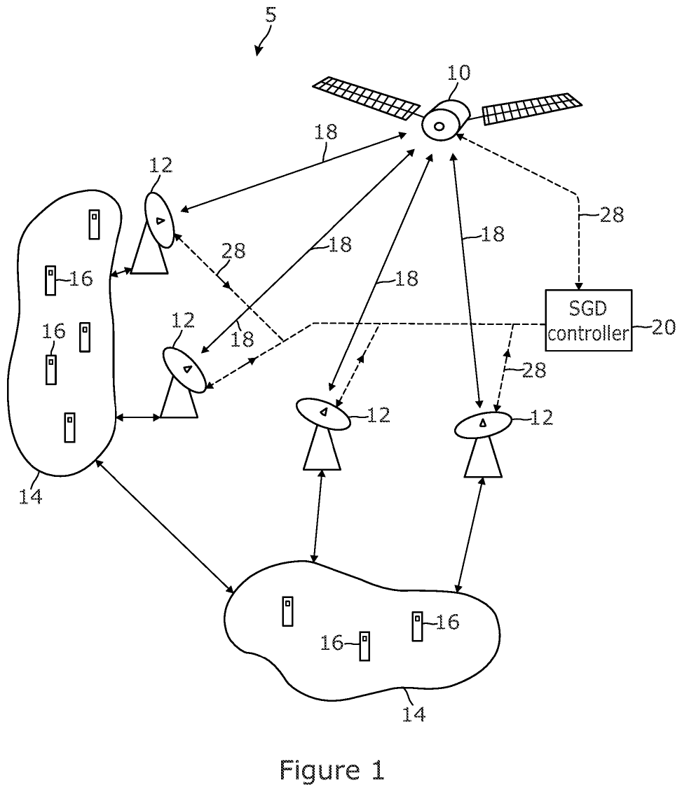

Referring to FIG. 1 there is illustrated a satellite communications system 5 comprising a satellite 10, and a plurality of gateways 12 comprised in or implemented using ground stations which are arranged to communicate data to and from the satellite 10. The gateways 12 may be associated with a number of local networks 14 within which terminal devices 16 such as mobile telephone handsets are connected. The satellite 10 and gateways 12 then enable terminal devices in one local network to readily communicate with terminal devices in another local network, over a group of feeder links 18 between associated gateways and the satellite.

In the illustrated system 5 the feeder links 18 are typically operated at higher frequency bands such as the Ka and V bands. At such higher frequency bands the feeder links 18 are subject to significant but variable levels of attenuation due to atmospheric conditions such as concentrations of water vapour, atmospheric turbulence, cloud, and especially rain. The fade margin which can be tolerated by a gateway 12 for its feeder link with the satellite 10 to continue to function can be the result of several margins built into the gateway's link budget, such as oversizing of the antenna, and oversizing of the gateway's high power amplifier. A gateway will typically also apply uplink power control to compensate for uplink fading while at the same time keeping under control co-channel interference between the gateways.

Since the fade properties of a gateway are dependent on factors including the frequency band used, when we refer to a gateway we generally refer to a gateway using a single such frequency band. Of course, a single ground station may then comprise two or more geographically collocated gateways each operating using a different frequency band.

If the fade margin for a gateway is exceeded due to excessive atmospheric attenuation, then a gateway is deemed to experience a fade outage, so that traffic which would have continued to be routed to and from the satellite using that gateway needs to be switched to another gateway. Such a switch can be triggered for example if the attenuation exceeds a site switching threshold (SST) for the gateway, which need not be the same as the fade margin. The choice of SST for a gateway may be very gateway specific, and reflect a number of design parameters and compromises such as choice of antenna size and high power amplifier as touched on above.

The satellite communications system 5 of FIG. 1 operates according to a smart gateway diversity (SGD) scheme in which an active gateway 12 typically continues to communicate data traffic to and from the satellite until attenuation of the feeder link 18 exceeds the SST for that gateway, at which point the active gateway becomes inactive and its traffic is switched to one or more of the other gateways which were inactive up to that point (in an “N active+P standby” scheme), or to one or more other gateways which have sufficient spare capacity (in an “N active” scheme).

In the arrangement of FIG. 1 this smart gateway diversity function and associated switching of gateways is coordinated or controlled by an SGD controller 20, which is provided with suitable control connections 28 with the satellite 10 and each of the gateways 12 (one or more control connections with gateways can be via the satellite, and/or vice versa if required). For an “N active+P standby” scheme with a single standby gateway such that P=1, when one gateway becomes inactive there is only one choice of gateway to make active. If P>1 there may be more than one inactive gateway available for the SGD controller to choose to make active.

If the group of feeder links 18 for the satellite 18 is operated according to an “N active+P standby” scheme then a switching event leads to an active gateway becoming a standby gateway, until attenuation conditions at one of the now active gateways leads to switching of traffic back to the original active gateway.

Regardless of the details of the SGD scheme, a switching event will typically lead to data flows within the system being temporarily compromised, for example when one or more connections are suspended or slowed for a short period as data flows within the system are rerouted to adapt to the switching event. One result of these switching delays is likely to be an undesirable reduction in quality of service to the terminal devices 16.

Regardless of the precise details of the data rerouting delays, switching between gateways therefore leads to a reduction in performance of the group of feeder links, for example in terms of how much data is transmitted in total. To minimise this reduction in performance the SGD controller 20 of FIG. 1 is arranged to predict fade outages of feeder links between ground station gateways 12 and the satellite 10, and using those predictions, to carry out switches between gateways under the SGD scheme in such as way so as to improve or optimize overall feeder link performance. For example, by having a predictions of fade outages from minutes to hours ahead, the SGD controller 20 can arrange for a switch expected to be required between two gateways to occur before a fade outage actually occurs, and can avoid switching to a gateway where a fade outage is expected to occur shortly, or expected to occur repeatedly over the near future.

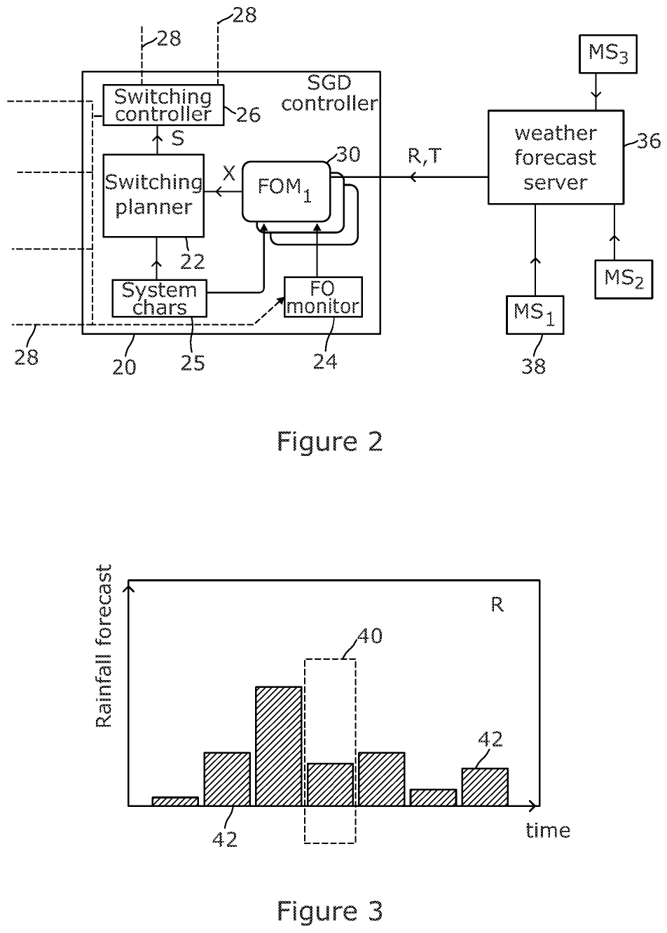

To this end, FIG. 2 illustrates how the SGD controller 20 of FIG. 1 may be implemented in more detail. The SGD controller implements or comprises one or more fade outage models 30 (FOM₁ . . . . FOMₙ) which have been trained, as discussed in more detail below, to provide a prediction X of fade outage for a future time point or interval, which we refer to as a prediction time interval. Although this fade outage prediction X may take various forms as discussed in more detail below, it may typically indicate whether or not the attenuation of a particular feeder link 18 between a particular gateway and satellite is expected to exceed a particular level at any time within the prediction time interval, where attenuation is the loss of signal beneath an optimum or unimpeded level.

This prediction may be made at least partly on the basis of rainfall forecast data R for the ground station gateway 12 for which the prediction is being made, and in particular such rainfall forecast data for a plurality of forecast time intervals which comprise time intervals after the prediction time interval, or optionally both time intervals before and time intervals after the prediction time interval. Such rainfall forecast data R may typically be received from one or more remotely located weather forecast servers 36, which may for example aggregate weather forecast data from a plurality of other weather forecast services 38 such as national or internationally based meteorological office services 38.

FIG. 3 illustrates aspects of such rainfall forecast data R as used by a fade outage model 30 to make fade outage predictions X. A prediction time interval 40 for which a fade outage model is to make a fade outage prediction for a particular gateway 12 is illustrated centrally in the graph by the broken box, and rainfall forecasts R for each of a number of discrete time intervals before and a number of discrete time intervals after the prediction time interval are shown, as well as a rainfall forecast for the prediction time interval itself. Typically, the rainfall forecast data will be available for discrete sequential time intervals of, say, 15 minutes, and the prediction time interval 40 may then correspond to one of those discrete time intervals.

The rainfall forecast data R may typically be forecasts of rain or precipitation at ground level, for example as a rate such as mm of liquid water per hour, or a total amount of liquid water in mm for the time interval. The geographical location of the rainfall forecast may correspond exactly to the position of the ground station for which the fade outage prediction is being made, to a nearby location, to a geographical area including the ground station, or to a nearby geographical area, for example depending on what rainfall forecast data R is available from the weather forecast server 36.

The inventors have found that by using rainfall forecast data for a plurality of time intervals after the prediction interval, and optionally also for a plurality of time intervals before the prediction interval, for a particular ground station gateway, rather than for example rainfall forecast data for just the prediction interval itself, the prediction of fade outage for the gateway is significantly improved.

The number of forecast time intervals of rainfall forecast data after, and optionally also before, the prediction interval which are used as input to the fade outage model 30 can be adjusted or selected to optimise the fade outage prediction, and may vary for example with factors such as latitude of the ground station (and so elevation angle to a geostationary satellite), local climatology (for example various types of maritime, continental, desert, tropical and other climates) and other factors. However, typically from about two to ten or twenty, for example at least three, or at least five, forecast time intervals may be used by the fade outage model for after the prediction time interval, and optionally from about two to ten or twenty, for example at least three, or at least five, forecast time intervals may also be used by the fade outage model for before the prediction time interval. Such forecast time intervals may each represent a length of time which is at least one minute, or at least five minutes, and/or no more than fifteen, and/or no more than thirty minutes. Typically, the multiple time intervals of rainfall forecast data used to make a fade outage prediction for a particular prediction time interval and for a particular gateway may extend to at least thirty minutes after, or at least an hour after, and optionally also at least thirty minutes before, or at least an hour before, the prediction time interval.

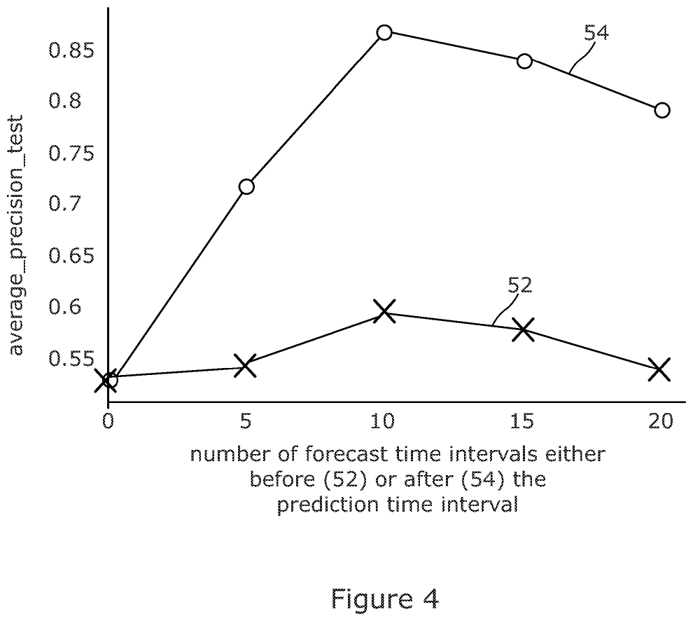

FIG. 4 illustrates the beneficial effect of using rainfall forecast data for a plurality of time intervals after, rather than before, the prediction interval. In experiments, fade outage models were implemented using random forest classifier tools, trained using feeder link attenuation data sampled at one minute intervals over a month from a gateway operating at 40 GHz and a site switching threshold (SST) of 5 dB. In each case a test set of data comprising two rainy days was removed from the training set.

A first set of fade outage models was trained to make fade outage predictions X on the basis of rainfall forecast data R only for the prediction interval itself and a number of “prior” consecutive time intervals before the prediction time interval, and no “post” time intervals after the prediction time interval. A different such model was trained using each of zero, five, ten, fifteen and twenty such prior time intervals.

Curve 52 of FIG. 4 plots an average precision measure for the trained models used on the test data, against the number of consecutive prior time intervals used. The average precision measure is a mean precision achieved by different probability thresholds weighted by the difference on recall. It can be seen that using only rainfall forecast data for the prediction interval itself (zero on the abscissa) leads to a relatively poor precision of about 0.53, rising to a maximum of about 0.6 for 10 prior time intervals in addition to the prediction interval.

A second set of fade outage models was then trained to make fade outage predictions X on the basis of rainfall forecast data R for the prediction interval itself, and a number of “post” consecutive time intervals after the prediction interval. A different such model was trained using each of zero, five, ten, fifteen and twenty such post time intervals.

Curve 54 of FIG. 4 plots an average precision measure for the trained models used on the test data, against the number of consecutive post time intervals used. It can be seen that the precision is considerably higher than for the prior time interval models, rising to a maximum of greater than 0.85 for 10 post time intervals in addition to the prediction interval.

FIG. 2 also shows various other optional aspects of the SGD controller 20, including a gateway switching planner 22 and a gateway switching controller 26. The gateway switching planner 22 receives output of the one or more fade outage models 30, and in particular predictions X of fade outages for each gateway which is under control of the controller 20, which have been made using the one or more fade outage models 30. The switching planner 22 then calculates a switching plan S based on these predictions which schedules switches of data traffic between gateways as described above in such a manner so as to improve or optimize performance of the group of feeder links, for example by minimising the expected number of switches and therefore improving overall feeder link availability over extended periods of time. To achieve this the switching planner 22 may use various types of algorithms.

Note that the switching plan S may extend several hours into the future, but since weather forecasts change as a forecasted time approaches, so the switching plan may also be changed accordingly as the predictions X made by the one or more fade outage models are updated to reflect the changing weather forecast. The switching plan S may typically be passed to the gateway switching controller 26, which then effects switching of data traffic between gateways where required, using suitable control links 28 to the gateways and satellite.

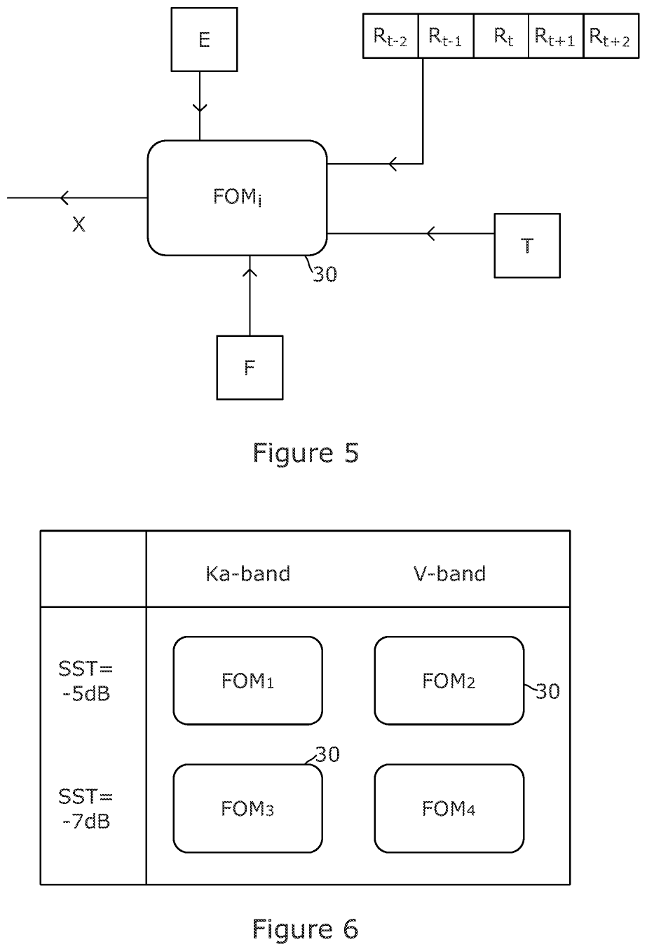

Also illustrated in FIG. 2 as part of the SGD controller is a fade outage monitor 24 which is arranged to receive data describing current or recent past levels of attenuation for each ground station gateway, and to determine actual fade outages of the corresponding feeder links, for example according to the same criterion as used in training corresponding fade outage models, noting that different criteria may be for different models. The fade outage monitor 24 then makes this actual fade outage data available as an input to the one or fade outage models, as discussed below in respect of the input data F shown in FIG. 5.

Also illustrated in FIG. 2 as part of the SGD controller is a set of system characteristics 25. These system characteristics comprise data which may be required by the fade outage models 30 and switching planner 22, such as the geographical locations of each ground station gateway and the elevation from each gateway to the satellite, the frequency band of operation of each gateway, the site switching threshold to be used for each gateway, the switching process delay as a time required to switch data traffic from one gateway to another, and so forth.

Although FIG. 2 and the discussion above relate to use of one or more fade outage models 30 which are trained to make predictions of fade outage based on forecasts of rainfall at multiple time intervals around a prediction time interval 40, the fade outage model(s) may be trained to provide such predictions based on additional input data, including one or more of the additional input data types illustrated in FIG. 5.

In FIG. 5, rainfall forecast data R is shown as an input to fade outage model FOM₁ for a plurality of time intervals including the prediction time interval itself t, one or more time intervals after the prediction time interval (shown here as t+1, t+2), and optionally one or more time intervals before the prediction time interval (shown here as t−2, t−1).

Another optional input to the fade outage model for further improving the prediction of fade outage is temperature forecast data Tfor a locality at or proximate to the gateway ground station, typically representing a dry bulb temperature close to ground level, or similar, although other temperature measures could be used. The temperature forecast data used could be a single temperature forecast T, for example covering or corresponding to at least the prediction time interval, as shown in FIG. 5, or for a single longer time interval such as the same interval as covered by all of the rainfall data inputs, or for multiple time intervals such as the same particular time intervals as the rainfall forecast data which in FIG. 5 could then be represented as T, Tₜ₊₁, T₁₊₂, and optionally also Tₜ₋₂, Tₜ₋₁.

The inventors have also established that use of data defining the actual occurrence of fade outages for a gateway prior to the prediction time interval is also able to improve the fade outage predictions, although in practice this can only be done when the prediction time interval is quite close ahead in time, for example less than about two hours away. None-the-less, for prediction of fade outage within a short period of say tens of minutes ahead of the prediction time interval, this technique provides very valuable improvements in model accuracy.

The technique of using actual fade outage as input to the model is illustrated in FIG. 5 by the input to the fade outage model 30 of one or more prior fade outage indications F, which indicate(s) whether a fade outage has actually been experienced by the gateway of concern in one or more time intervals before the prediction time interval. Such data may readily be acquired by obtaining attenuation data for the relevant feeder link 18 from the associated gateway, and for example determining if the attenuation exceeded a fade outage margin or site switching threshold, or met some other relevant criterion, within one or more prior time intervals, or for at least a minimum amount of time within such prior time intervals.

Typically, for example, the fade outage indication(s) F may comprise a binary flag which indicates whether or not the relevant gateway experienced any fade outage during a period of thirty to sixty minutes before the prediction time interval, or some other time period. However, multiple such flags each for a different prior time period could be used, for example between 30 and 60 minutes, and between 60 and 90 minutes before the prediction interval.

Although as discussed below, separate fade outage models 30 may be trained for each of a plurality of ground station gateways, or clusters or classes of such gateways, another optional input to a fade outage model which has been found by the inventors to be useful in improving performance when a model is trained for use in respect of multiple gateways is an elevation measure E, for example representing the elevation angle of the beam between the ground station and satellite, with respect to the ground. For geostationary satellites this is closely linked to the geographical latitude of the ground station. Because a beam of lower elevation has a longer atmospheric path that passes through rainfall and other atmospheric disturbances that are more distant from the ground station itself, the inventors have found that including an elevation measure E as input allows a fade outage model to be applicable with reasonable accuracy to multiple different ground stations.

However, because training data at a large number of different elevation angles is unlikely to be readily available, the elevation measure E may be input as a limited class of options rather than a numerical value, for example a flag indicating whether the elevation angle falls within certain ranges, such as above or below 25 degrees.

Factors such as frequency band of the feeder link, and/or the value of the site switching threshold (SST) beyond which the attenuation gives rise to a positive prediction of fade outage, may also be used as inputs into particular fade outage models, but the inventors have established that these factors are frequently better addressed by use of multiple fade outage models, each trained and used for a particular combination of frequency band and SST as discussed below.

As illustrated in FIG. 2, multiple fade outage models 30 may be used by an SGD controller 20 or in respect of an SGD scheme. For example, each such model could be used for making fade outage predictions for a particular different ground station gateway, or for particular classes or groups of ground stations. For example, a different model could be trained and used for ground stations in each of a plurality of different climate types, geographical areas, latitudinal zones, or ranges of elevation angle between the ground station and satellite. However, from experiments conducted by the inventors in training and evaluating such models, these factors may not be of sufficient influence to make training and use of such multiple models to be worthwhile, except probably for the use of some measure or class of elevation angle E as discussed above.

However, the inventors have observed that training and using different fade outage models for different radio frequency bands of the feeder links 18 leads to valuable improvements in performance of the SGD scheme. For example, the fade outage models 30 provided in an SGD controller may comprise one or more fade outage models trained and used for feeder links 18 operating in the Ka band, and one or more different fade outage models trained and used for feeder links 18 operating in the V band. This is useful because attenuation behaviour for any particular rainfall event or other atmospheric disturbance is found to be considerably different for feeder links using different frequency bands. Each such fade outage model trained and used on a particular frequency band may then be used for multiple gateways and feeder links using that frequency band.

As an alternative, one or more fade outage models could each be trained with a frequency band classification as an input to the model.

The inventors have also observed that training and using different fade outage models for different levels of site switching threshold (SST), fade margin, or a similar parameter leads to valuable improvements in performance, where the SST or similar parameter may be the attenuation level beyond which the fade outage model provides a positive prediction of fade outage. For example, the fade outage models 30 provided in an SGD controller may comprise one or more fade outage models trained and used for feeder links 18 operating within each of two or more different ranges of SST, for example above and below an SST value of 5 dB.

With the above in mind, FIG. 6 illustrates a group of fade outage models 30 which might be used in SGD controller 20 to provide fade outage predictions for a number of different ground station gateways. In this figure, FOM₁ and FOM₂ provide fade outage models for use where the SST for a gateway or feeder link is set at a value of 5 dB, while FOM₃ and FOM₄ provide fade outage models for use where the SST for a gateway or feeder link is set at a value of 7 dB.

Similarly, FOM₁ and FOM₃ provide fade outage models for use where a gateway or feeder link is to operating in the K-band, while FOM₂ and FOM₄ provide fade outage models for use where a gateway or feeder link is operating in the V-band.

As discussed above, each of one or more fade outage models is trained and used to provide a prediction X of fade outage based on input data such as rainfall forecast data.

Typically, this prediction X may be a binary indicator, for example indicating whether or not the attenuation of the feeder link 18 of concern is expected to meet or exceed a fade outage criterion for the prediction time interval. Typically, this fade outage criterion may be whether or not the attenuation from an unimpeded level exceeds a particular threshold at any point of time within the time interval, at least for a certain proportion of the time interval, or on the basis of some other criterion. The threshold typically used in such a criterion may be the site switching threshold (SST), and the fade outage criterion may then be whether or not the attenuation is expected to exceed the SST at any point within the prediction time interval. In such cases, a particular fade outage model may be trained to provide a prediction X in respect of only a single particular SST.

Training the or each fade outage model to provide a binary indication of fade outage may lead the fade outage models to be easier to train effectively, especially if the amount of training data available is limited. However, one or more of the fade outage models may instead be trained and used to provide a multiclass or multinomial prediction X of fade outage. Such a multiclass prediction could for example comprise three or more classes, with each class representing a different expected proportion of time within the prediction time interval that fade outage will occur, or some combination of such expectations.

For example, if the multiclass output of a fade outage model can be represented as [unlikely|moderately likely|very likely] then the switch planning module 22 of FIG. 2, or other algorithmic function making use of the predictions, can generate a switching plan S which takes account of these probabilities to optimize the performance of the feeder network 5.

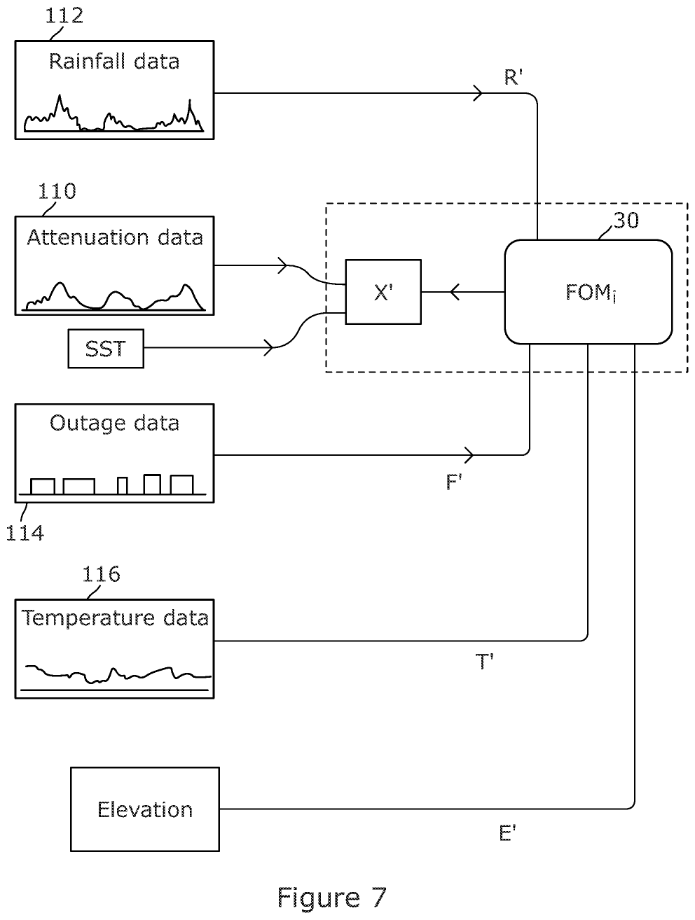

FIG. 7 illustrates how a fade outage model 30, FOM₁ may be trained for use in smart gateway diversity control as described above. One or more time series of attenuation data 110 for the feeder link 18 with a particular ground station gateway, and one or more corresponding time series of rainfall data 112 for the same time period, are provided. The time series are paired so that a particular time series of attenuation data is for the same ground station as a corresponding time series of rainfall data, but multiple such pairs may be used in the described training, from multiple ground stations. The one or more ground stations used for this training could be or include ground stations for which the trained model will also be used operationally as discussed above, but this is not necessarily the case.

The attenuation data 110 is typically readily available or derivable from data routinely acquired by a ground station in monitoring its radio or telecommunications link with a satellite, and is likely to be represented as a number of dB below the unimpaired link power as measured at either the ground station, the satellite, or both. As shown in FIG. 7, by defining a particular site switching threshold (SST), one or more corresponding time series of fade outage data X′ can be defined, which represent when the ground station was deemed to be in fade outage according to the SST criterion.

The rainfall data 112 may be available from rain gauge measurements made at the sites of the one or more ground stations. Alternatively, rainfall data from one or more forecast models, for example from the same weather forecast server 36 as depicted in FIG. 2 and to be used for fade outage predictions, could be used as a proxy for the actual rainfall data.

In preparing the rainfall data 112 and attenuation data 110 for use in the training process to provide R′ and X′ as depicted in FIG. 7, some averaging or re-windowing may be required to ensure that the time intervals of the R′ and X′ data correspond to the size of the prediction time interval to be used by the fade outage model operationally, and to the size of the forecast time intervals of the rainfall forecast data to be used. For example, if ground station rain gauge data is available for 5 minute windows, but the rainfall forecast data is available for 15 minute windows, then the rain gauge data may be averaged or otherwise processed to provide 15 minute windows for R′.

The fade outage model FOM₁ is then trained to provide an optimized prediction of X′ on the basis of input data R′. How this training is implemented will depend on the type of statistical or artificial intelligence scheme used to implement the fade outage model, as discussed in more detail below. However, typically, the time series for R′ and X′ may be divided into a training data set, a validation data set, and a test set, with the fade outage model being repeatedly or iteratively trained using the training data set to achieve optimized prediction of P′ in the validation data set, without overfitting such that the fade outage model becomes unsuitable for predicting fade outage using new input data not present in the training data set, and the test set then being used to assess accuracy or errors of the trained fade outage model, and to assess degree of under or over fitting.

As well as being trained to predict X′ using R′ as input, the model may be trained to use one or more various further inputs such as those illustrated in FIG. 7, which correspond to further inputs for operational use as already discussed in respect of FIG. 5. These include prior fade outage indications F′ which can be derived from one or more time series of prior fade outage data 114 for the gateway. Although shown as a separate data set in FIG. 7, the value of F′ for a particular prediction time interval may instead be calculated from values for X′ for one or more earlier time intervals.

For example, if a particular value of the fade outage indictor X′ is a binary indicator of fade outage for a current time interval of fifteen minutes, then the corresponding value of F′ may indicate “prior fade outage” if the value of X′ indicated a fade outage in either of the two immediately prior fifteen minute intervals, or may indicate “no prior fade outage” if the value of X′ indicated no fade outage in either of the two immediately prior fifteen minute intervals.

The optional further inputs also include a temperature input T′ derived from one or more temperature data time series 116 for the ground station corresponding in time to the rainfall and attenuation data time series. The temperature data could for example be obtained from a same meteorological station at the ground station as used to collect rainfall data used for training the fade outage model, from some other local temperature measure, or from forecast model data.

If the rainfall data and other time series include time series for multiple different ground stations, then the fade outage model may also be trained to make a prediction X′ based on one or more properties of the different ground stations or gateways, such as an elevation measure E′, as already discussed above on connection with FIG. 2. Other potential properties on which a fade outage model could be trained include frequency band of operation, and site switching threshold, although as discussed above it may be more appropriate to train separate models for different values of these parameters.

The fade outage models 30 may be implemented using a variety of statistical and/or artificial intelligence or automated machine learning techniques. For example if the widely available H2O tool set is used (for example see www.h2o.ai) then the fade outage models may be implemented using the automated machine learning module of the package for either binary or multi-class classification (for example see the options discussed here: https://docs.h2o.ai/h2o/latest-stable/h2o-docs/automl.html).

Using the H2O automated machine learning module to implement our fade outage models, a number of H2O machine learning models may be trained, for example in the following order: three pre-specified XGBoost (Extreme Gradient Boosting) GBM (Gradient Boosting Machine) models, a fixed grid of GLMs (Generalized Linear Models), a default Random Forest (DRF), five pre-specified H2O GBMs, a near-default Deep Neural Net, an Extremely Randomized Forest (XRT), a random grid of XGBoost GBMs, a random grid of H2O GBMs, and a random grid of Deep Neural Nets. A list of the hyperparameters searched over for each algorithm in the AutoML process is already defined in the automl module.

To implement the fade outage models, the H2O automl module may be used with 40 models, at the same time as balancing the classes, as the fade outage problem is a highly imbalanced classification problem. AutoML can then be used to train two Stacked Ensemble models. One ensemble contains all the models, and the second ensemble contains just the best performing model from each algorithm class/family. For the selection of the best of the models one may use the H2O metric of Precision-Recall Area Under Curve.

As aforementioned, the fade outage model problem is highly imbalanced and therefore it is desirable to calculate the precision and the recall for every probability threshold. For a 15-minute resolution of rainfall forecast data, and the same time resolution of attenuation data from a gateway operating at a radio frequency of 40 GHz and a site switching threshold (SST) of 5 dB, the best model provided with H2O tended to be a stacked model with the best models of each family using 1 year of data for training.

The output of each model may then be the probability that at a given point there is feeder link attenuation higher than the SST. For the transformation of the probability to a decision of whether there will be an outage, in order to complete the fade outage model, one can then compare the probability to a probability threshold. This probability threshold may for example be the one that maximises the F1-score. The error a model provides should then be compared with the validation data sets in order to determine whether there is overfitting or under-fitting and to therefrom adapt any features of the algorithm.

Another widely available set of tools which may be used to implement the fade outage models is provided by the open source Python toolkit TPOT (see http://epistasislab.github.io/tpot/). TPOT uses genetic programming to provide an optimized pipeline for a particular machine learning problem. TPOT considers multiple machine learning algorithms (random forests, linear models, SVMs, etc.) in a pipeline with multiple pre-processing steps (missing value imputation, scaling, PCA, feature selection, etc.), the hyper parameters for all of the models and pre-processing steps, as well as multiple ways to ensemble or stack the algorithms within the pipeline.

The described fade outage models have been implemented using the default TPOT settings (100 generations with 100 population size) and therefore TPOT evaluates 10,000 pipeline configurations before finishing. For a 15-minute resolution of rainfall forecast and attenuation data, gateway frequency of 40 GHz and an SST 5 dB, the best model provided with TPOT was a stacked model with Gaussian Naïve Bayes Classifier and a pipeline of a standard scaler with Extra Trees Classifier using 1 year of data for training.

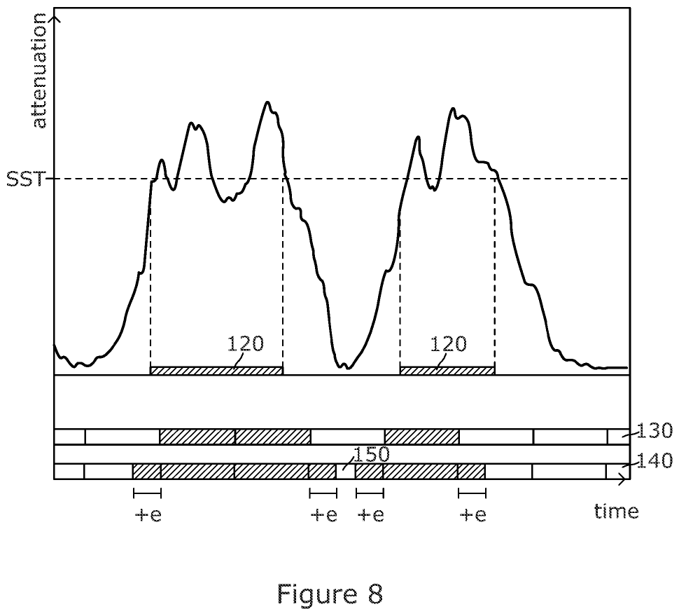

FIG. 8 illustrates how the fade outage models 30 described above may be used by the switching planner 22 or some other control element in determining when to make traffic switches between gateways in a smart gateway diversity scheme. FIG. 8 is a plot of attenuation of a feeder link 18 between a gateway 12 and a satellite 10, over a period of around two hours. The two groups of peaks are each caused by rainfall passing through the beam of the connection, which will typically be accompanied by a similar but not identical pattern of rainfall onto the ground station itself.

At some points in the period illustrated the attenuation on the feeder link exceeds a site switching threshold (SST) for the link. For these intervals at least, the switching planner 22 needs to have made provision for switching data traffic away from this to another gateway. Moreover, since the task of switching between gateways involves a switching delay, which may be of the order of a few tens of seconds, and multiple switching back and forth between gateways over periods of minutes is therefore impractical, FIG. 8 illustrates two impairment intervals 120 during which time use of this particular gateway for carrying traffic is not practical.

The two bars along the bottom of the plot are divided into fifteen minute prediction time intervals. The upper of these two bars, labelled as 130, is shaded within those intervals for which a fade outage model as described above has predicted, perhaps a couple of hours ahead on the basis of rainfall forecast data, that a fade outage will occur in at least a part of that interval. It can be seen that, in these predictions made on the basis of forecast rainfall data quite far ahead, the fade outage periods are predicted with a reasonable but not complete level of accuracy. Because this prediction is made quite far ahead, the potential for prediction error is higher. Therefore the switching planner may add adjustments of time +e to either end of the fade outage periods to arrive at the predicted impairment intervals shown as shaded areas of bar 140.

The adjustment of time +e used may vary, for example being larger for predictions further ahead in time, and may in some circumstances by negative thereby shortening the predicted impairment interval, for example for fade outage predictions made close to the prediction time interval.

The second of the predicted impairment intervals 140 shown in FIG. 8 still does not quite cover the entire fade outage period 120 which is subsequently experienced by the gateway, even including the added adjustment time +e, but revisions of the predicted impairment intervals 140 closer to the time of the second fade outage peak group will usually correct this, as better rainfall forecast data is received. The gap 150 of five minutes or so between the two predicted impairment intervals may be too short to be worth switching back to this gateway, given the switching delays involved, and the switching planner 22 may therefore decide to exclude such a switch back to this gateway in the switching plan S shown in FIG. 2.

The SGD controller 20 illustrated in FIGS. 1 and 2, the fade outage models shown in FIGS. 5 and 6, the process of training a fade outage model illustrated in FIG. 7, the methods of use of the fade outage model predictions for smart gateway diversity control, and other aspects of the disclosure, may typically be implemented using computer program code executing on one or more suitable computer systems. Such computer systems may be co-located at a single place, or widely distributed and connected to each other using suitable data network connections. Control systems within the ground station gateways, and within the satellite, will also typically be implemented in a similar way, and arranged to transmit data to, and receive control signals from the SGD controller, using suitable data network connections.

In any case, such computer systems may typically each comprise one or more computer processors or microprocessors arranged to execute the computer program code, the processors being coupled to suitable volatile and/or non-volatile memory for storing the computer program code and associated data for example including data defining the trained fade outage models. Such computer systems may also typically be provided with suitable input and output peripherals such as screen, keyboard and mouse, or may be implemented as servers typically not connected to any such peripherals, but controllable over suitable data network connections.

Although specific embodiments of the invention have been described with reference to the drawings, the skilled person will be aware that variations and modifications may be applied to these embodiments without departing from the scope of the invention defined in the claims.

1. A method of providing a prediction of fade outage of a feeder link between a satellite and a ground station gateway within a prediction time interval comprising:
receiving rainfall forecast data for the gateway for a plurality of forecast time intervals which comprise a plurality of time intervals after the prediction time interval;
providing the rainfall forecast data as input to a trained fade outage model; and
outputting by the trained fade outage model, in response to the input, the prediction of fade outage for the prediction time interval.

2. The method of claim 1 wherein the fade outage model is trained to predict a fade outage if attenuation of the feeder link is expected to exceed a predefined threshold such as, or related to, a site switching threshold (SST) or a fade margin.

3. The method of claim 1 wherein the plurality of forecast time intervals comprise at least three time intervals after the prediction time interval.

4. The method of claim 1 wherein the plurality of forecast time intervals also comprise a plurality of time intervals, or at least three time intervals, before the prediction time interval.

5. The method of claim 1 wherein each forecast time interval is one or both of: at least five minutes in length; and not more than thirty minutes in length.

6. The method of claim 1 wherein the prediction time interval is one or both of at least five minutes in length, and not more than thirty minutes in length.

7. The method of claim 1 wherein one or more of the following are also provided as part of the input to the trained outage model:
temperature forecast data for one or more time intervals that at least overlap with at least one of the forecast time intervals or the prediction time interval; and
an elevation measure representative of an elevation angle between the ground station and the satellite.

8. The method of claim 1 wherein fade outage data is also provided as part of the input to the trained outage model,
wherein the fade outage data represents actual fade outages of the feeder link within one or more time periods before the prediction interval, wherein the one or more time periods optionally lie within one hour before, or two hours before the prediction time interval.

9. The method of claim 1 wherein the prediction of fade outage is a binary prediction of whether or not a fade outage will occur within the prediction time interval, or a multiclass prediction with five or fewer classes.

10. The method of claim 1 wherein there are a plurality of said ground station gateways, the method comprising:
outputting predictions of fade outage of feeder links between the satellite and each of the plurality of ground station gateways; and
controlling the switching of data traffic between the gateways at least partly on the basis of the predictions of fade outage.

11. The method of claim 10 wherein controlling switching of data traffic comprises making an active ground station gateway inactive and/or making an inactive ground station active, at least partly on the basis of one or more of the predictions of fade outage.

12. The method of claim 10 wherein each feeder link is in one of a plurality of radio frequency bands, and further comprising providing a plurality of fade outage models such that each fade outage model is specific to one of said radio frequency bands, each prediction of fade outage being made using a fade outage model specific to the frequency band of the associated feeder link.

13. The method of claim 10 wherein each gateway has an associated site switching threshold, SST, such that there are a plurality of different associated SSTs, and further comprising providing a plurality of fade outage models such that each fade outage model is specific to one of said SSTs, each prediction of fade outage being made using a fade outage model specific to the SST of the associated feeder link.

14. A method of training a fade outage model for use in predicting fade outage of feeder links between ground stations and satellites, comprising:
providing training data comprising one or more time series of rainfall and one or more corresponding time series of attenuation of one or more feeder links, each time series of rainfall being for the same ground station gateway as a corresponding time series of attenuation;
defining one or more fade outage criteria which are at least partly dependent on the attenuation; and
using the training data to train the fade outage model to predict if one or more of the fade outage criteria will be met for a future prediction interval, using as input to the fade outage model rainfall forecast data for a plurality of forecast time intervals which comprise a plurality of time intervals after the prediction time interval.

15. The method of claim 14 wherein the one or more fade outage criteria comprise the attenuation meeting, or exceeding, a predefined threshold, such as, or related to, a site switching threshold or a fade margin.

16. The method of claim 14 wherein the plurality of forecast time intervals comprise at least three time intervals after the prediction time interval.

17. The method of claim 16 wherein the plurality of forecast time intervals further comprise a plurality of time intervals, or at least three time intervals, before the prediction time interval.

18. An apparatus for providing a prediction of fade outage of a feeder link between a satellite and a ground station gateway within a prediction time interval, the apparatus comprising one or more computer processors arranged to:
receive rainfall forecast data for the gateway for a plurality of forecast time intervals which comprise a plurality of time intervals after the prediction time interval;
provide the rainfall forecast data as input to a trained fade outage model; and
output by the trained fade outage model, in response to the input, the prediction of fade outage for the prediction time interval.

19. The apparatus of claim 18 wherein the fade outage model is trained to predict a fade outage if attenuation of the feeder link is expected to exceed a predefined threshold such as, or related to, a site switching threshold (SST) or a fade margin.

20. Apparatus for controlling a group of feeder links between a satellite and a plurality of ground station gateways, comprising:
one or more fade outage models arranged to make predictions of fade outage of the feeder links between the satellite and the ground station gateways,
each fade outage model being arranged to receive as input, rainfall forecast data for the gateway for a plurality of forecast time intervals which comprise a plurality of time intervals after a prediction time interval, and to output, in response to the input, a prediction of fade outage for the prediction time interval.

21. The apparatus of claim 20 wherein the plurality of forecast time intervals comprise one or more of: at least three forecast time intervals after the prediction time interval; a plurality of time intervals before the prediction time interval; at least three forecast time intervals before and at least three forecast intervals after the prediction time interval.

22. The apparatus of claim 20 wherein each of the forecast time intervals is from five to thirty minutes in length.

23. The apparatus of claim 20 further comprising a switching planner, the switching planner being arranged to receive the predictions of fade outage from the one or more fade outage models, and to output a switching plan which schedules switches of data traffic between the ground station gateways.

24. The apparatus of claim 23 wherein the switching plan schedules switching of active ground station gateways carrying data traffic to an inactive status, and inactive ground station gateways not carrying data traffic to active status.

25. The apparatus of claim 23 further comprising a gateway switching controller arranged to switch data traffic between gateways according to the switching plan.

26. The apparatus of claim 20 wherein each feeder link is in one of a plurality of radio frequency bands, and the one or more fade outage models comprise a plurality of fade outage models such that each fade outage model is specific to one of said radio frequency bands, the apparatus being arranged such that each prediction of fade outage is made using a fade outage model specific to the frequency band of the associated feeder link.

27. The apparatus of claim 20 further comprising a fade outage monitor arranged to determine actual fade outages of the feeder links within one or more time periods before each prediction time interval, and to provide said actual fade outages as further input to said one or more fade outage models.

28. The apparatus of claim 18 wherein one or more of the following are also provided as part of the input to the trained outage model:
temperature forecast data for one or more time intervals that at least overlap with at least one of the forecast time intervals or the prediction time interval; and
an elevation measure representative of an elevation angle between the ground station and the satellite.

29. One or more computer readable media comprising computer program code arranged to carry out the following steps implemented on a suitable computer system:
receive rainfall forecast data for the gateway for a plurality of forecast time intervals which comprise a plurality of time intervals after the prediction time interval;
provide the rainfall forecast data as input to a trained fade outage model; and
output by the trained fade outage model, in response to the input, the prediction of fade outage for the prediction time interval.
